(19) United States
(12) Patent Application Publication
(10) Pub. No.: US 2026/0336525 A1
(43) Pub. Date: Oct. 29, 2026

(54) Adaptable Storage Systems for Vehicles

(71) Applicant: Nissan North America, Inc, Franklin, TN (US)

(72) Inventors: David Kovie, Livonia, MI (US); Srikanth Reddy Baddam, Northville, MI (US); Luke Cordes, Bloomfield Hills, MI (US); Ronald Morrow, Novi, MI (US); Joseph Brown, Northville, MI (US)

(21) Appl. No.: 19/188,693

(22) Filed: Apr. 24, 2025

(51) Int. Cl. B60R 5/04; B60R 7/02; B60R 7/04; B60R 11/00

(52) U.S. Cl. CPC B60R 5/044; B60R 7/02; B60R 7/043; B60R 2011/0015; B60R 2011/0019; B60R 2011/0029

(57) ABSTRACT

An adaptable storage system for a vehicle has a panel with a first panel piece with a first perimeter size and shape, a second panel piece having a second perimeter size and shape that is the same as the first perimeter size and shape, and a handle accessible from one or both of the first panel piece and the second panel piece. The panel is configured to fit within a cavity in an interior of the vehicle, trunk, or truck bed. The panel has a first position in which the panel is within the cavity and mimics a vehicle surface surrounding the cavity and a second position in which the panel provides a modular storage mounting board. The handle is configured to move the panel between the first position and the second position.

### TECHNICAL FIELD

This disclosure relates to adaptable storage systems for any type of vehicle, the adaptable storage systems configured to be easily accessible when needed and hidden when not in use.

### BACKGROUND

Vehicles are equipped with storage areas, which can include truck beds, van interiors, front and rear trunks, open areas when seats are removed, etc. Work vehicles may be equipped with storage accessories. However, users of non-work vehicles may not want to equip storage areas with accessories that are permanent or would interfere with various uses of the storage areas.

### SUMMARY

Disclosed herein are implementations of adaptable storage systems for vehicles.

In an implementation, an adaptable storage system for a vehicle has a panel with a first panel piece with a first perimeter size and shape, a second panel piece having a second perimeter size and shape that is the same as the first perimeter size and shape, and a handle accessible from one or both of the first panel piece and the second panel piece. The panel is configured to fit within a cavity in an interior of the vehicle, trunk, or truck bed. The panel has a first position in which the panel is within the cavity and mimics a vehicle surface surrounding the cavity and a second position in which the panel provides a modular storage mounting board. The handle is configured to move the panel between the first position and the second position.

In another implementation, an adaptable storage system for a vehicle has a panel comprising: a first panel piece with a first perimeter size and shape and a first surface; a second panel piece having a second perimeter size and shape that is the same as the first perimeter size and shape and a second surface facing opposite the first surface, wherein the first panel piece and the second panel piece are spaced apart from and connected to each other with spacers; and a handle accessible from both of the first panel piece and the second panel piece. The panel is configured to fit within a cavity in an interior of the vehicle, trunk, or truck bed. The panel has a first position in which the first surface faces out of the cavity and mimics a vehicle surface surrounding the cavity and a second position in which the second surface faces out of the cavity and provides a modular storage mounting board. The handle is configured to remove the panel from the cavity, allowing selection of one of the first position and the second position when the panel is reinserted into the cavity.

In another implementation, an adaptable storage system for a vehicle has a panel comprising: a first panel piece with a first perimeter size and shape, the first panel piece having apertures through a thickness of the first panel piece; a second panel piece having a second perimeter size and shape that is the same as the first perimeter size and shape, the second panel piece having protrusions sized to fit within corresponding apertures; and a handle accessible from the first panel piece. The panel is configured to fit within a cavity in an interior of the vehicle, trunk, truck cab or truck bed. The panel has a first position in which the protrusions are in the apertures and a second position in which the protrusions are not in the apertures, the first panel piece providing a modular storage mounting board. The handle is configured to move the panel between the first position and the second position.

These and other aspects of the present disclosure are disclosed in the following detailed description of the embodiments, the appended claims and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic view of the rear of a vehicle, the rear of the vehicle opened to show the interior of the vehicle and the adaptable storage systems disclosed herein in a first position.

FIG. 2 is a schematic view of the rear of a vehicle, the rear of the vehicle opened to show the interior of the vehicle and the adaptable storage systems disclosed herein in a second position.

FIG. 3 is an adaptable storage system as disclosed herein partially within a cavity.

FIG. 4 is a plan view of the adaptable storage system of FIG. 3 in the second position, showing the modular storage mounting board.

FIG. 5 is a plan view of the adaptable storage system of FIG. 3 in the first position, mimicking the vehicle surround.

FIG. 6 is an exploded view of the adaptable storage system of FIG. 3.

FIG. 7 is a perspective view of the adaptable storage system of FIG. 3 external the vehicle.

FIG. 8 is a perspective view of another implementation of an adaptable storage system as disclosed herein.

FIG. 9 is a perspective view of the adaptable storage system of FIG. 8 in a second position in which the modular storage mounting board is accessible.

FIGS. 10A and 10B are cross-sections and illustrate the adaptable storage system of FIG. 8 in a first position and a second position, respectively.

FIG. 11 is another implementation of an adaptable storage system as disclosed herein.

FIG. 12 shows the adaptable storage system of FIG. 11 in a second position.

FIG. 13 is a side view of the adaptable storage system of FIG. 11.

FIG. 14 illustrates an example of a handle mechanism for an adaptable storage system as disclosed herein.

FIG. 15 illustrates another example of a handle mechanism for an adaptable storage system as disclosed herein.

### DETAILED DESCRIPTION

Vehicles are equipped with storage areas, which can include truck beds, van interiors, front and rear trunks, open areas when seats are removed, the back of seats, etc. These storage areas may be modified to include storage systems to allow for items to be secured, hung, or otherwise connected to the storage system to keep items in place during travel and allow for better organization. However, these storage systems are typically permanent. Users of the vehicle may not need to use the permanent storage systems on a regular basis. For example, permanent storage systems may obstruct the storage area, preventing its use for other situations in which the permanent storage system is not needed. Such permanent systems may prevent the use of a removable row of seats or may reduce the amount of passenger space, as non-limiting examples.

Disclosed herein are adaptable storage systems designed to provide opportunity for adaptable functionality, improving the vehicle users’ experience. The adaptable storage systems disclosed herein may be used in any area that can function as a storage area and are adaptable between a position in which the storage system is available to the user in the storage area and a position in which the storage system does not obstruct the storage area and is not viewable or usable in the storage area. As non-limiting uses, the adaptable storage system may be used when the vehicle is used for a camping trip, hunting trip, sporting event, hobbies, etc. When the vehicle is used on a day-to-day basis, such as for transporting passengers, the adaptable storage system can be in the position in which the storage system does not obstruct the storage area and is not viewable or usable in the storage area.

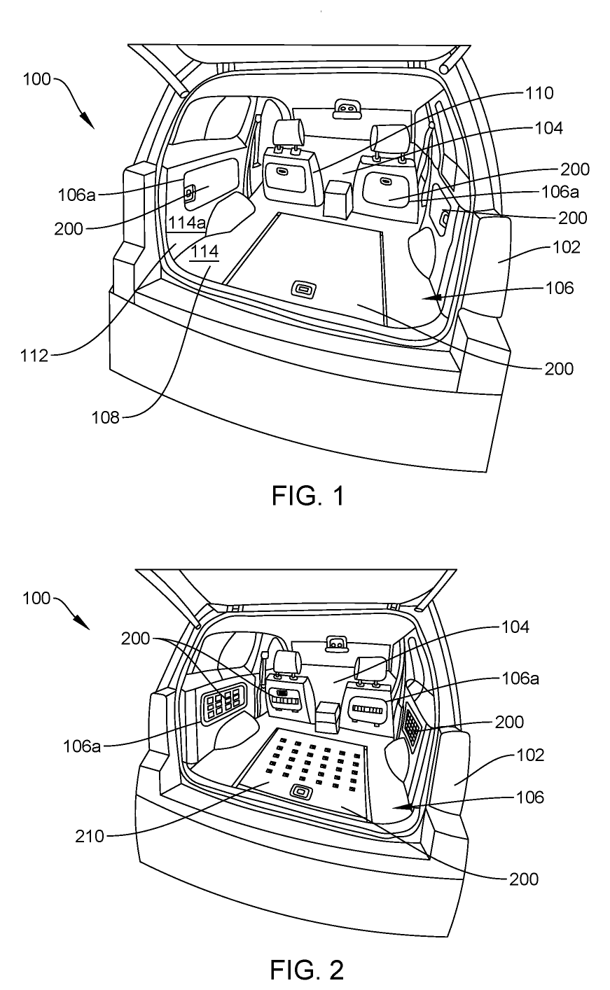

FIGS. 1 and 2 are a schematic illustration of a vehicle 100 that includes a vehicle body 102. The vehicle 100 may be a passenger vehicle that includes a passenger compartment 104 that is configured to carry one or more passengers. Alternatively, the vehicle 100 may be a truck or cargo vehicle that is primarily configured to carry cargo items in a cargo compartment but which also includes the passenger compartment 104 (e.g., for carrying a driver). As another alternative, the vehicle 100 may be a recreational vehicle (an RV) that also includes the passenger compartment 104. In the illustrated implementation, the vehicle 100 is a road-going vehicle in which the vehicle body 102 is supported by wheels. Although shown with respect to a road-going vehicle, the disclosure herein may be applicable to any suitable vehicle that includes a vehicle body and a passenger compartment. For example, the disclosure herein may be applicable to aerial vehicles, off-road vehicles, marine vehicles, or any other suitable type of vehicle.

The vehicle has a cavity 106 that can be used as a storage area. The cavity 106 may be the cargo area of a van, sports utility vehicle (SUV), hatch back, station wagon, RV, pick-up truck or the trunk of a sedan, as non-limiting examples. The cavity 106 may include one or more sub-cavity 106a such as a seat back or interior vehicle panel, including a floor panel.

An adaptable storage system 200 for the vehicle 100 may be configured for use in the cavity 106 or sub-cavity 106a. One or more adaptable storage system 200 may be used within the vehicle 100. As illustrated in FIGS. 1 and 2, the adaptable storage systems 200 are shown in the floor 108 of cavity 106 and in sub-cavities 106a, the two passenger seats 110 and the interior vehicle panels 112. Each adaptable storage system 200, described in detail in the remaining figures, has a first position in which the adaptable storage system 200 is within the cavity 106 or sub-cavity 106a and mimics a vehicle surface 114, 114a surrounding the cavity 106 or sub-cavity 106a. This is illustrated in FIG. 1. Each adaptable storage system 200 has a second position in which the adaptable storage system 200 provides a modular storage mounting board 210 that is accessible to the user from within the vehicle 100 and in some instances, from external the vehicle 100, such as standing at the rear of the vehicle 100. This is illustrated in FIG. 2.

FIGS. 2-13 illustrate implementations of adaptable storage systems 200. The adaptable storage system 200 has a panel 202 with a first panel piece 204 with a first perimeter size and shape, a second panel piece 206 having a second perimeter size and shape that is the same as the first perimeter size and shape, and a handle 208 accessible from one or both of the first panel piece 204 and the second panel piece 206. The panel 202 is configured to fit within a cavity 106 as used herein, (reference to cavity 106 includes reference to sub-cavity 106a) in an interior of the vehicle 100, trunk, truck cab, or truck bed. The panel 202 has a first position shown in FIGS. 1 and 5, in which the panel is configured to fit within the cavity 106 and mimics a vehicle surface 114 surrounding the cavity 106 and a second position, shown in FIGS. 2 and 4, in which the panel 202 provides a modular storage mounting board 210. The handle 208 is configured to move the panel 202 between the first position and the second position.

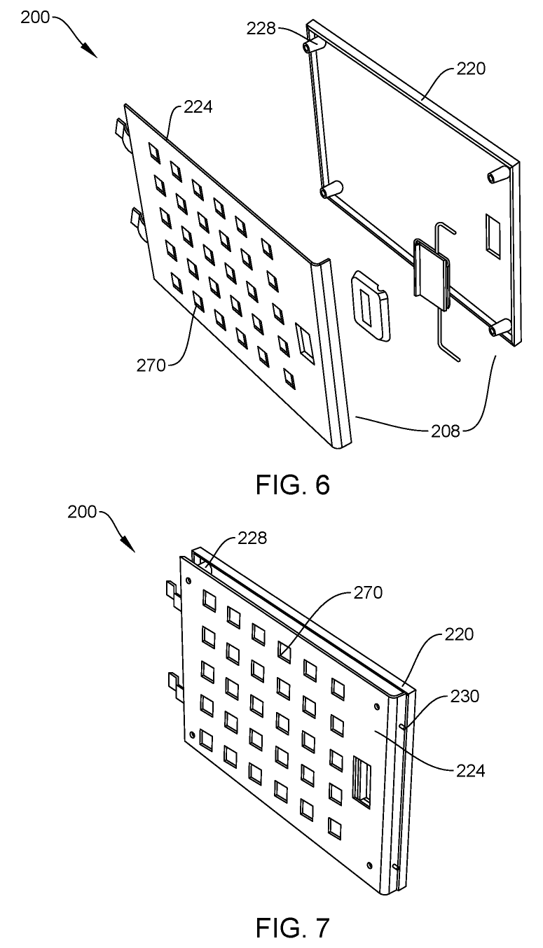

In FIGS. 2-7, the panel 202 of the adaptable storage system 20 has a first panel piece 220 with a first perimeter size and shape and a first surface 222 and a second panel piece 224 having a second perimeter size and shape that is the same as the first perimeter size and shape and a second surface 226 facing opposite the first surface 222. The first panel piece 220 and the second panel piece 224 are spaced apart from and connected to each other with spacers 228, best seen in FIG. 6. The handle 208 is accessible from both of the first panel piece 220 and the second panel piece 224. In the first position of the panel 202, the first surface 222 is displayed, facing out of the cavity 106 and mimicking a vehicle surface 114 surrounding the cavity 106. In the second position of the panel 202, the second surface 226 faces out of the cavity 106 and provides the modular storage mounting board 210. The handle 208 is configured to remove the panel 202 from the cavity 106, allowing selection of one of the first position and the second position when the panel 202 is reinserted into the cavity 106. The user grasps the handle and pulls out the panel 202. The user may either select to hide the modular storage mounting board 210, selecting the first position in which the first surface 222 is exposed, so the cavity 106 is filled with the panel 202 and looks substantially seamless with the surrounding vehicle surface 114. Alternatively, the user may select to have the modular storage mounting board 210 accessible for use.

The first panel piece 220 may be made of plastic and be the same color(s) and/or texture of the surrounding vehicle interior. The second panel piece 224 may be made of plastic or metal and is designed to be of sufficient mechanical strength to support the storage attachments and stored items, as further described below. The metal may be powder-coated.

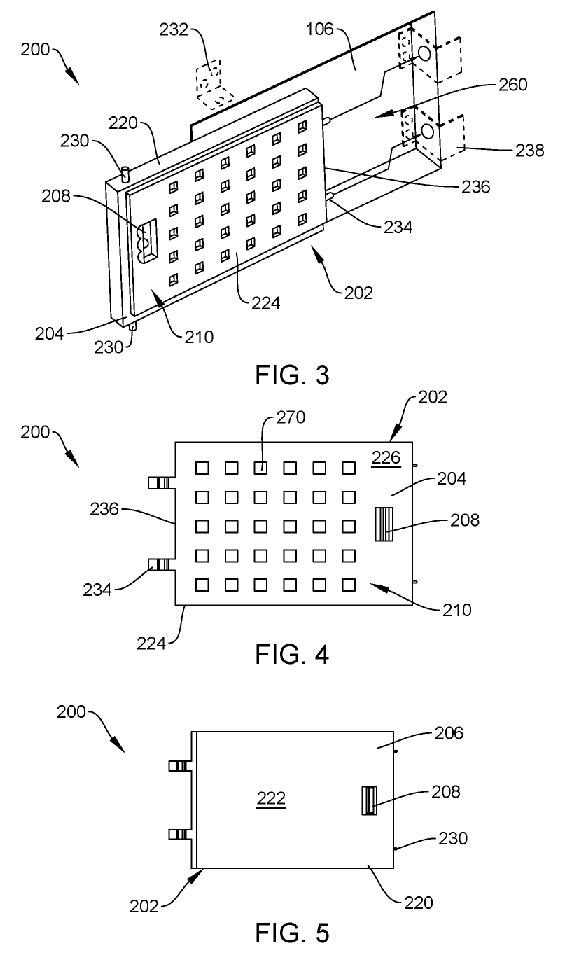

To secure the panel 202 within the cavity 106, the panel 202 has a movable extension 230 extending through the panel 202 and configured to be held in a corresponding bracket 232 within the cavity 106. As illustrated in FIG. 3, the panel 202 has two movable extensions extending through the panel 202 at opposing side edges. As illustrated in FIGS. 4 and 5, the panel 202 has two movable extensions extending through the panel 202 at a handle end of the panel 202. These are other means of securing the panel 202 are contemplated and not meant to be limiting. The handle 208 is configured to pull a movable extension 230 into the panel 202 and out of the bracket 232 to allow for removal of the panel 202 from the cavity 106. At least one of the first panel piece 220 and the second panel piece 224 has an end extension 234 extending from an insert end 236 and configured to be held in a corresponding end bracket 238 within the cavity 106 to further secure the panel 202 within the cavity 106. Two end extensions are illustrated in the figures as a non-limiting example. The end extension 234 may be peg-shaped or clip-shaped or any other configuration to secure the panel 202.

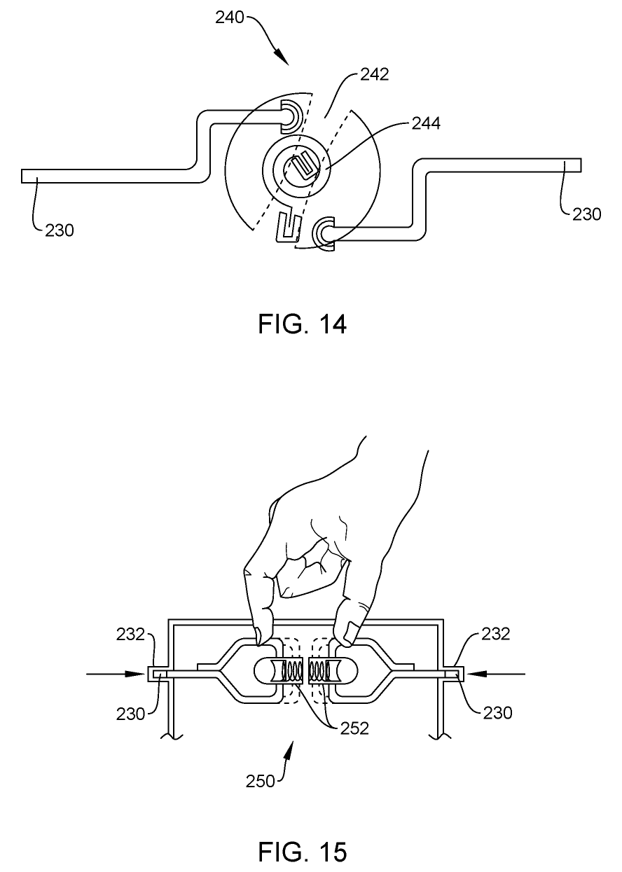

FIGS. 14 and 15 provide non-limiting examples of handle mechanisms that functions to move the movable extensions 230. In FIG. 14, the rotatable handle mechanism 240 would be grasped by the user at member 242 and rotated. The rotation would move the movable extensions 230 inward by tightening a spring 244. When member 242 is released, the spring 244 would untighten, or expand, moving the movable extensions 230 outward to their resting configuration. The panel 202 can be removed from the cavity 106 when the spring 244 is tightened and the movable extensions 230 are moved into the panel 202.

FIG. 15 is another non-limiting example of a linear handle mechanism 250 that functions to move the movable extensions 230. In FIG. 15, the user would squeeze or pinch together sliding members 252 which are connected to the movable extensions 230. When the sliding members 252 are moved toward one another, the movable extensions 230 move inward into the panel 202 and out of the brackets 232, allowing for the panel 202 to be removed from the cavity 106. When the sliding members 252 are released, the movable extensions 230 are biased to the outward, original position.

The cavity 106 may be configured to have a storage compartment 260 within the cavity 106, the storage compartment 260 being accessible by removing the panel 202. The storage compartment can be used to store items whether the panel 202 is in the first position or second position. The storage compartment 260 may contain an outlet so that stored items may be charged while being stored in the storage compartment.

The modular storage mounting board 210 is shown in FIGS. 2-7 having uniformly sized apertures 270 through the second panel piece 224 configured to mount storage accessories. The size of the apertures 270 and the number of apertures 270 can vary from the illustration. The apertures 270 may be sized to use with a particular line or lines of storage accessories already on the market. The modular storage mounting board 210 may be similar to a peg board onto which the storage accessories are attached. The storage accessories may include, but are not limited to straps, pouches, ladders, D-rings, webbing, hooks, cubby holes, twist-cam locks, racks, baskets, etc. The modular storage mounting board 210 may include hooks as well as the apertures 270.

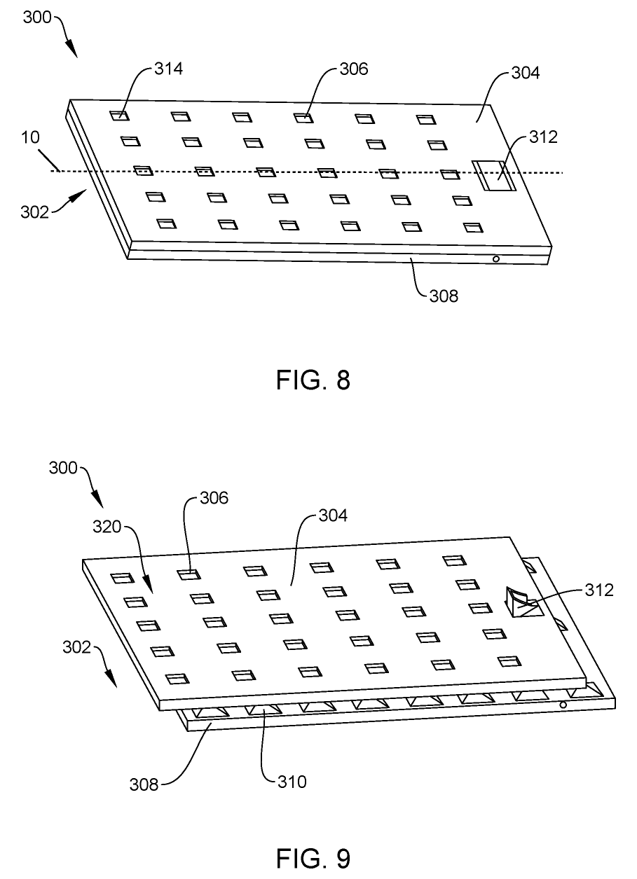

Another implementation of an adaptable storage system 300 is illustrated in FIGS. 8-10B. The adaptable storage system 300 has a panel 302 comprising: a first panel piece 304 with a first perimeter size and shape, the first panel piece 304 having apertures 306 through a thickness T of the first panel piece 304. The panel 302 has a second panel piece 308 having a second perimeter size and shape that is the same as the first perimeter size and shape, the second panel piece 308 having protrusions 310 sized to fit within corresponding apertures 306. The adaptable storage system 300 also has a handle 312 accessible from the first panel piece 304.

The panel 302 is configured to fit within a cavity 106 in an interior of the vehicle, trunk, truck cab, or truck bed, similar to panel 202. The panel 300 has a first position in which the protrusions 310 are in the apertures 306. When the protrusions 310 are in the apertures 306, a distal end 314 of the protrusions 310 fills a corresponding aperture 306 to that the distal end 314 is flush with the first panel piece 304, thereby mimicking the vehicle surface 114 surrounding the cavity 106. The panel 302 has a second position in which the protrusions 310 are not in the apertures 306, so that the first panel piece 304 provides a modular storage mounting board 320 that is accessible to the user from within the vehicle 100 and in some instances, from external the vehicle 100, such as standing at the rear of the vehicle 100. The modular storage mounting board 320 is shown in FIG. 9 having uniformly sized apertures 306 through the first panel piece 304 configured to mount storage accessories. The size of the apertures 306 and the number of apertures 306 can vary from the illustration. The apertures 306 may be sized to use with a particular line or lines of storage accessories already on the market. The modular storage mounting board 320 may be similar to a peg board onto which the storage accessories are attached. The storage accessories may include, but are not limited to straps, pouches, ladders, D-rings, webbing, hooks, cubby holes, twist-cam locks, racks, baskets, etc. The modular storage mounting board 320 may include hooks as well as the apertures 306 assessable in the second position.

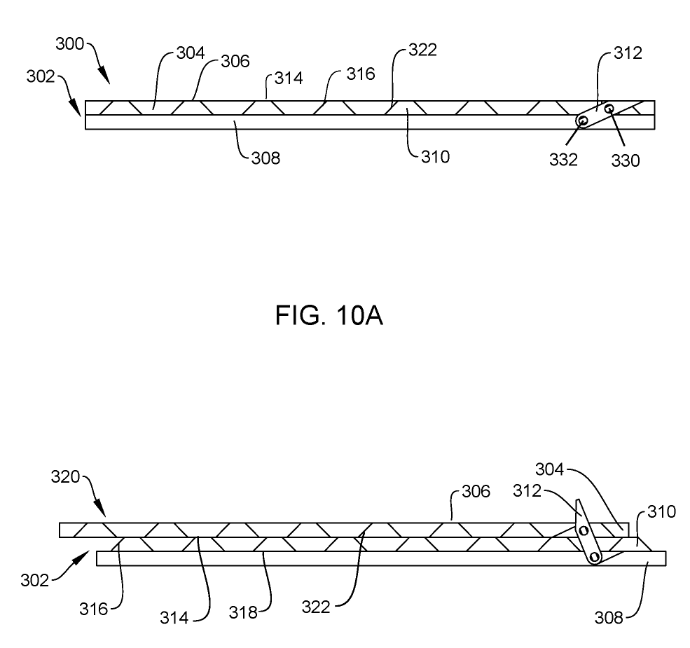

The handle 312 is configured to move the panel 302 between the first position and the second position as shown in FIGS. 10A and 10B, which are cross-sectional illustrations through line 10 of FIG. 8. The handle 312 can be attached to a first rod 330 to the first panel piece 304 and attached to the second panel piece 308 with a second rod 332, as one example. Rods 330, 332 can fit tightly in the first panel piece 304 and the second panel piece 308 while the handle 312 rotates freely on the rods. The handle 312 moves the panel 302 between the first position and the second position by moving the first panel piece 304 away from the second panel piece 308 until the protrusions 310 exit the apertures 306 and by moving the first panel piece 304 parallel to the second panel piece 308 so the protrusions 310 contact the first panel piece 304 between the apertures 306, shown in FIG. 10B. Each protrusion 310 can have a sloped side surface 316 such that each protrusion 310 has more area at a base 318 than at the distal end 314. The first panel piece 304 may also have sloped side surfaces 322 sloping inward and away from an adjacent aperture such that the first panel piece 304 and the second panel piece 308 fit together to form the panel 302 as a contiguous piece. The protrusions 310 have a height substantially equal to the thickness of the first panel piece 304.

The panel 302 is secured within the cavity 106 at the second panel piece 308 with hinges, for example, connecting the first panel piece 304 and the second panel piece 308. In other implementations, the panel 302 may be removeable in its entirety in a manner similar to panel 202 to access within the cavity 106 a storage compartment within the cavity 106, the storage compartment being accessible by removing the panel 302. The storage compartment can be used to store items whether the panel 302 is in the first position or second position. The storage compartment may contain an outlet so that stored items may be charged while being stored in the storage compartment.

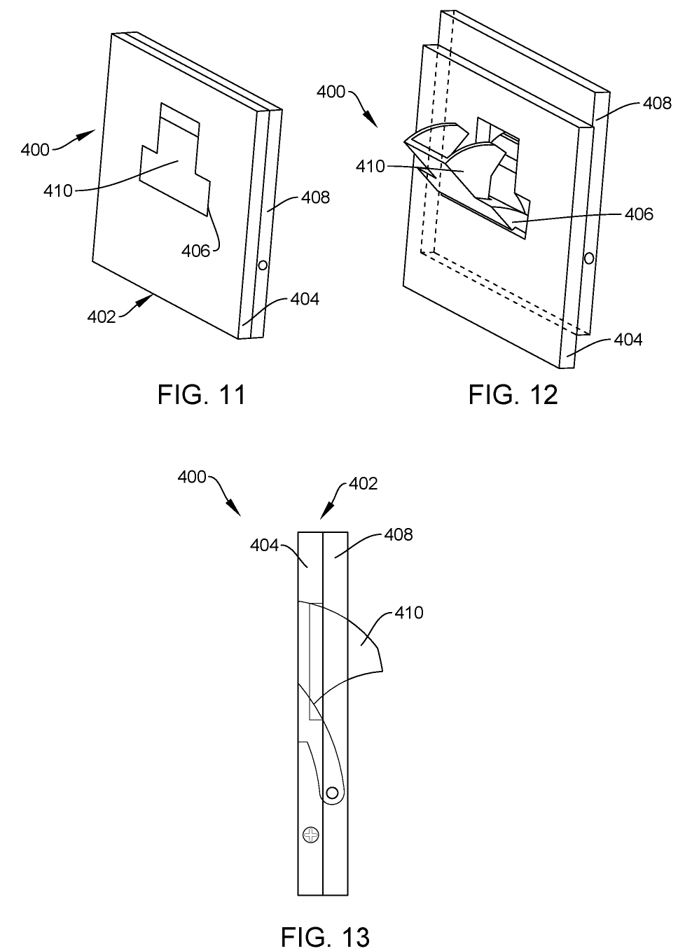

FIGS. 11-13 illustrate another implementation of an adaptable storage system 400 configured for sub-cavities 106a in which the adaptable storage system 400 would be mounted vertically, such as in a seat back or interior vehicle panel. The adaptable storage system 400 has a panel 402 comprising: a first panel piece 404 with a first perimeter size and shape, the first panel piece 404 having an aperture 406 through a thickness of the first panel piece 404. The panel 402 has a second panel piece 408 having a second perimeter size and shape that is the same as the first perimeter size and shape. The adaptable storage system 400 also has a handle 410 accessible from the first panel piece 404.

The panel 402 has a first position in which the handle 410 is in stowed the closed position, as shown in FIGS. 11 and 13, thereby mimicking the vehicle surface 114 surrounding the sub-cavity 106a. The panel 402 has a second position in which the handle 410 is pulled down, forming a hook on which items may be hung, as shown in FIG. 12. The panel 402 is secured within the sub-cavity 106a at the second panel piece 408 with hinges, for example, connecting the first panel piece 404 and the second panel piece 408. In other implementations, the panel 402 may be removeable in its entirety in a manner similar to panel 202 to access within the sub-cavity 106a a storage compartment within the sub-cavity 106a, the storage compartment being accessible by removing the panel 402. The storage compartment can be used to store items whether the panel 402 is in the first position or second position. The storage compartment may contain an outlet so that stored items may be charged while being stored in the storage compartment.

The adaptable storage systems disclosed herein may be used across multiple vehicles. For example, an adaptable storage system that is used in a seat back of a sedan may also be used in the seat back of a different sedan or a pick-up truck or SUV. The adaptable storage systems may be used in conjunction with the Utili-Track® system found in many Nissan vehicles.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An adaptable storage system for a vehicle, comprising:
a panel comprising:
a first panel piece with a first perimeter size and shape;
a second panel piece having a second perimeter size and shape that is the same as the first perimeter size and shape; and
a handle accessible from one or both of the first panel piece and the second panel piece,
wherein:
the panel is configured to fit within a cavity in an interior of the vehicle, trunk, or truck bed,
the panel has a first position in which the panel is within the cavity and mimics a vehicle surface surrounding the cavity,
the panel has a second position in which the panel provides a modular storage mounting board, and
the handle is configured to move the panel between the first position and the second position.

2. The adaptable storage system of claim 1, wherein:
the first panel piece and the second panel piece are spaced apart from and connected to each other with spacers;
a first surface of the first panel piece facing away from the second panel piece is displayed in the cavity in the first position;
a second surface of the second panel piece facing away from the first panel piece is displayed in the cavity in the second position; and
the handle is accessible from both the first panel piece and the second panel piece, the handle configured to remove the panel from the cavity, allowing selection of one of the first position and the second position when the panel is reinserted into the cavity.

3. The adaptable storage system of claim 2, wherein at least one of the first panel piece and the second panel piece have an end extension extending from an insert end configured to be held in a corresponding end bracket within the cavity.

4. The adaptable storage system of claim 2, wherein:
the panel has a movable extension extending through an edge of the panel and configured to be held in a corresponding bracket within the cavity; and
the handle is configured to pull the movable extension into the panel to allow for removal of the panel from the cavity.

5. The adaptable storage system of claim 1, wherein the first panel piece is made of plastic and the second panel piece is made of plastic or metal.

6. The adaptable storage system of claim 1, wherein the modular storage mounting board has uniformly sized apertures through the second panel piece configured to mount storage accessories.

7. The adaptable storage system of claim 1, wherein the modular storage mounting board has hooks assessable in the second position.

8. The adaptable storage system of claim 1, wherein the cavity is within a floor of the interior or the trunk or within a floor of a truck cab or the truck bed.

9. The adaptable storage system of claim 1, wherein the cavity is within a seat back of the vehicle.

10. The adaptable storage system of claim 1, further comprising:
a storage compartment within the cavity and accessible when the panel is removed from the cavity.

11. The adaptable storage system of claim 1, wherein:
the first panel piece has apertures through a thickness of the first panel piece and the second panel piece has protrusions sized to fit within the apertures, the protrusions having a height substantially equal to the thickness of the first panel piece,
the protrusions are in the apertures in the first position, and
the protrusions are not in the apertures in the second position.

12. The adaptable storage system of claim 11, wherein the handle is accessible from the first panel piece, the handle moving the panel between the first position and the second position by moving the first panel piece away from the second panel piece until the protrusions exit the apertures and moving the first panel piece parallel to the second panel piece so the protrusions contact the first panel piece between the apertures.

13. The adaptable storage system of claim 1, wherein the handle is accessible from the first panel piece, the handle is stowed in the first position, and the handle is pulled outward and down around a hinge to form a hook in the second position.

14. An adaptable storage system for a vehicle, comprising:
a panel comprising:
a first panel piece with a first perimeter size and shape and a first surface;
a second panel piece having a second perimeter size and shape that is the same as the first perimeter size and shape and a second surface facing opposite the first surface, wherein the first panel piece and the second panel piece are spaced apart from and connected to each other with spacers; and
a handle accessible from both of the first panel piece and the second panel piece,
wherein:
the panel is configured to fit within a cavity in an interior of the vehicle, trunk, or truck bed,
the panel has a first position in which the first surface faces out of the cavity and mimics a vehicle surface surrounding the cavity,
the panel has a second position in which the second surface faces out of the cavity and provides a modular storage mounting board, and
the handle is configured to remove the panel from the cavity, allowing selection of one of the first position and the second position when the panel is reinserted into the cavity.

15. The adaptable storage system of claim 14, wherein:
the panel has a movable extension extending through an edge of the panel and configured to be held in a corresponding bracket within the cavity; and
the handle is configured to pull the movable extension into the panel to allow for removal of the panel from the cavity.

16. The adaptable storage system of claim 14, wherein the first panel piece is made of plastic and the second panel piece is made of metal.

17. The adaptable storage system of claim 14, wherein the modular storage mounting board has uniformly sized apertures through the second panel piece configured to mount storage accessories.

18. An adaptable storage system for a vehicle, comprising:
a panel comprising:
a first panel piece with a first perimeter size and shape, the first panel piece having apertures through a thickness of the first panel piece;
a second panel piece having a second perimeter size and shape that is the same as the first perimeter size and shape, the second panel piece having protrusions sized to fit within corresponding apertures; and
a handle accessible from the first panel piece,
wherein:
the panel is configured to fit within a cavity in an interior of the vehicle, trunk, or truck bed,
the panel has a first position in which the protrusions are in the apertures,
the panel has a second position in which the protrusions are not in the apertures, the first panel piece providing a modular storage mounting board, and
the handle is configured to move the panel between the first position and the second position.

19. The adaptable storage system of claim 18, wherein the handle moves the panel between the first position and the second position by moving the first panel piece away from the second panel piece until the protrusions exit the apertures and moving the first panel piece parallel to the second panel piece so the protrusions contact the first panel piece between the apertures.

20. The adaptable storage system of claim 18, wherein each protrusion has a sloped side surface such that each protrusion has more area at a base than at a distal end.
